(19) United States
(12) Patent Application Publication
(10) Pub. No.: US 2025/0122953 A1
(43) Pub. Date: Apr. 17, 2025

(54) AUTOMATIC VALVE FOR CLEANING THE SENSOR SURFACES OF AN AUTONOMOUS VEHICLE

(71) Applicant: A. Raymond et Cie, Grenoble (FR)

(72) Inventor: Stéphane Baron, Magstatt le Bas (FR)

(21) Appl. No.: 18/684,571

(22) PCT Filed: Aug. 31, 2022
(86) PCT No.: PCT/EP2022/074245

§ 371 Date: Feb. 16, 2024

(30) Foreign Application Priority Data
Sep. 6, 2021 (FR) 2109285

(51) Int. Cl. F16K 41/10; B60S 1/48; B60S 1/56

(52) U.S. Cl. CPC F16K 41/103; B60S 1/48; B60S 1/56

(57) ABSTRACT

An automatic valve comprises a valve body provided with a fluid duct. The valve body comprises a diaphragm configured to seal off the fluid duct when the diaphragm is in the closed position and allow fluid to flow through the fluid duct when the diaphragm is in the open position. Moreover, the automatic valve comprises an actuator. The actuator includes a stop, a spring, and a piston. The piston is configured to move between an engaged position and a disengaged position. Moreover, the actuator also comprises activation means configured to cause the piston to move toward its disengaged position so as to enable the diaphragm to adopt the open position. Finally, the actuator comprises a damping body, positioned between the second end and the stop, having a rigidity lower than a rigidity of the main body.

### CROSS REFERENCE TO RELATED APPLICATIONS

This application is a national phase entry under 35 U.S.C. § 371 of International Patent Application PCT/EP2022/074245, filed Aug. 31, 2022, designating the United States of America and published as International Patent Publication WO 2023/031298 A1 on Mar. 9, 2023, which claims the benefit under Article 8 of the Patent Cooperation Treaty to French Patent Application Serial No. FR2109285, filed Sep. 6, 2021.

### TECHNICAL FIELD

The present disclosure relates to the automotive field and, in particular, to that of autonomous vehicles. More particularly, the present disclosure relates to an automatic valve for cleaning the sensor surfaces of an autonomous vehicle. In particular, the present disclosure relates to a quieter automatic valve than valves known from the prior art.

### BACKGROUND

Motor vehicles are now equipped with numerous sensors or cameras (hereinafter “sensors”) for driving assistance purposes. These sensors are arranged over the entire perimeter of the vehicle, for example, in the bumpers and/or side skirts, and thus offer the driver complete visibility of the environment wherein the vehicle is located.

However, these sensors, exposed to the environment, are likely to become covered with dirt or dust and, therefore, their performance can become degraded. Frequent cleaning of these sensors is therefore necessary to guarantee their performance.

In this respect, motor vehicles can be equipped with a cleaning system, in particular, provided with ducts and nozzles for dispensing cleaning fluids. The nozzles are, in particular, arranged at the ends of the fluid distribution ducts and near the sensors. These cleaning systems can also comprise automatic valves making it possible to select the sensor(s) to be cleaned and thus limit the consumption of cleaning fluid.

In this respect, document EP 3792535 discloses an automatic valve that can be implemented in a motor vehicle cleaning system.

In particular, this automatic valve, known from the prior art, comprises:
a fluid duct connecting a fluid inlet and a fluid outlet;
a diaphragm arranged to adopt, by deformation, either a closed position or an open position, the diaphragm sealing off the fluid duct when it is in the closed position and allowing fluid to flow in the fluid duct from the fluid inlet to the fluid outlet when it is in the open position;
an actuator provided with a stop, a spring, and a piston that extends from a first end to a second end along an elongation axis, the piston being configured to move, by translation along the elongation axis, between an engaged position or a disengaged position, the piston adopting, by default and under the action of the spring, the engaged position wherein it holds the diaphragm in its closed position, the actuator further comprising activation means configured to force the movement of the piston toward its disengaged position for which it is in abutment, via its second end, against the stop and allows the diaphragm to adopt the open position.

However, such an automatic valve, when the piston is forcing a movement from its engaged position to its disengaged position, generates a noise that is likely to cause a nuisance in the passenger compartment of the motor vehicle.

One aim of the present disclosure is therefore to propose an automatic valve that is quieter than valves known in the prior art.

### BRIEF SUMMARY

The purpose of the present disclosure is achieved by an automatic valve for cleaning surfaces, advantageously surfaces of driving assistance sensors for a vehicle, which comprises:
a valve body provided with a fluid duct connecting a fluid inlet and a fluid outlet of the valve body;
a diaphragm arranged to adopt, by deformation, either a closed position or an open position, the diaphragm sealing off the fluid duct when it is in the closed position and allowing fluid to flow in the fluid duct from the fluid inlet to the fluid outlet when it is in the open position;
an actuator provided with a stop, a spring and a piston, the piston, which comprises a main body extending from a first end toward a second end along an axis of elongation, is configured to move in translation along the axis of elongation between an engaged position and a disengaged position, the piston adopting, by default and under the action of the spring, the engaged position wherein the piston holds the diaphragm in its closed position, the actuator further comprising activation means that are configured to force the piston to move in the direction of the stop toward its disengaged position so as to allow the diaphragm to adopt the open position, the actuator comprising a damping body, which is positioned between the second end and the stop having a rigidity below that of the main body so as to dampen the movement of the piston when the piston moves from its engaged position toward its disengaged position.

According to one embodiment, the actuator comprises a cylindrical guide body,

the guide body being provided with a bottom surmounted by a wall, referred to as a guide wall, delimiting a housing wherein the piston is arranged in sliding connection, the wall comprising an edge opposite the bottom and delimiting an opening.

According to one embodiment, the bottom of the guide body forms the stop.

According to one embodiment, the bottom comprises a peripheral zone and a central zone recessed relative to a reference plane defined the peripheral zone, while the central zone forms the abutment.

According to one embodiment, the damping body is generally cylindrical in shape and comprises a first section and a second section, which has a smaller diameter than that of the first section so as to form a shoulder, referred to as a bearing shoulder.

According to one embodiment, the spring is arranged coaxially with the second section and bears against the bearing shoulder.

According to one embodiment, the first section and the second section are each made of a different material.

According to one embodiment, the damping body is partially housed in a housing of the main body.

According to one embodiment, the second section is in projection relative to the second end.

According to one embodiment, the spring also bears against the stop.

According to one embodiment, the damping body comprises a polymeric material. Advantageously, the polymeric material is an elastomeric material.

According to one embodiment, the main body comprises, from the second end toward the first end, a cylindrical ferromagnetic yoke and an output shaft, which has a diameter smaller than that of the ferromagnetic yoke so as to form a first shoulder.

According to one embodiment, the actuator also comprises a cover that sealably caps the edge of the guide body, advantageously by means of a seal.

According to one embodiment, the cover comprises a circular opening and provides a passage for the output shaft.

According to one embodiment, the activation means comprise at least one electromagnetic coil, advantageously wound around the guide body.

According to one embodiment, the valve body comprises a seat, which is arranged in the fluid duct between the fluid inlet and the fluid outlet, and against which seat the diaphragm is pressed when the piston is in its engaged position.

According to one embodiment, the diaphragm comprises an elastomeric material.

The present disclosure also relates to a fluid assembly for cleaning surfaces, advantageously sensor surfaces, of a vehicle, the assembly comprising:
at least one automatic valve according to the present disclosure;
a tank of cleaning liquid;
at least one supply duct that fluidically connects the tank of cleaning liquid and the fluid inlet of the at least one automatic valve; and
at least one nozzle, which is fluidically connected to the fluid outlet of the at least one automatic valve and is arranged to spray the cleaning liquid onto a surface of the vehicle.

### BRIEF DESCRIPTION OF THE DRAWINGS

Other features and advantages of the present disclosure will emerge from the following detailed description of an embodiment of an automatic valve according to the present disclosure with reference to the appended figures, wherein:

FIG. 1 is a schematic representation, in perspective view, of an automatic valve according to the present disclosure;

FIG. 2 is a schematic representation, according to an exploded and perspective view, of the automatic valve of FIG. 1;

FIG. 3 is a schematic representation, along a cutting plane comprising the radial axis XX′ and the elongation axis YY′ of a valve body capable of being implemented within the scope of the present disclosure;

FIG. 4 is a schematic representation, along a cutting plane comprising the radial axis XX′ and the elongation axis YY′ of an automatic valve within the scope of the present disclosure, the piston being in its engaged position;

FIG. 5 is a schematic representation, along a cutting plane comprising the radial axis XX′ and the elongation axis YY′ of an automatic valve within the scope of the present disclosure, the piston being in its disengaged position;

FIG. 6 is a schematic representation, along a longitudinal cutting plane (passing through the elongation axis YY′) of an actuator capable of being implemented within the scope of the present disclosure;

FIG. 7 is a schematic representation, along a longitudinal cutting plane (passing through the elongation axis YY′) of another actuator capable of being implemented within the scope of the present disclosure;

FIG. 8 is a schematic representation of a piston capable of being implemented within the scope of the present disclosure;

FIG. 9 is a schematic representation, along a longitudinal cutting plane (passing through the elongation axis YY′), which guide body may be implemented within the scope of the present disclosure;

FIG. 10 is a schematic representation, in perspective view, of a damping means capable of being implemented within the scope of the present disclosure;

FIG. 11 is a schematic representation of a motor vehicle provided with a fluid assembly for cleaning sensor surfaces.

### DETAILED DESCRIPTION

The present disclosure relates to an automatic valve for cleaning the sensor surfaces of an autonomous vehicle. In particular, the automatic valve comprises a valve body provided with a fluid duct connecting a fluid inlet and a fluid outlet of the body.

The valve body further comprises a diaphragm arranged to adopt, by deformation, either a closed position or an open position. In particular, the diaphragm is configured to seal off the fluid duct when it is in the closed position, and to allow fluid to flow through the fluid duct from the fluid inlet to the fluid outlet when it is in the open position.

Moreover, the automatic valve also comprises an actuator intended to control the flow of a cleaning fluid in the fluid duct.

The actuator is provided with a stop, a spring, and a piston. In this respect, the piston comprises a main body that extends from a first end to a second end along an elongation axis. The piston is, in particular, configured to move, by translation along the elongation axis, between an engaged position and a disengaged position. The piston is more particularly suitable for adopting, by default, and under the action of the spring, the engaged position wherein it holds the diaphragm in its closed position. Moreover, the actuator also comprises activation means configured to force the movement of the piston, in the direction of the stop, toward its disengaged position so as to allow the diaphragm to adopt the open position.

Finally, the actuator comprises a damping body, interposed between the second end and the stop, and having a rigidity below that of the main body so as to dampen the movement of the piston when it moves from its engaged position to its disengaged position.

The implementation of the damping body makes it possible to attenuate the sound emissions when the piston moves from its engaged position to its disengaged position.

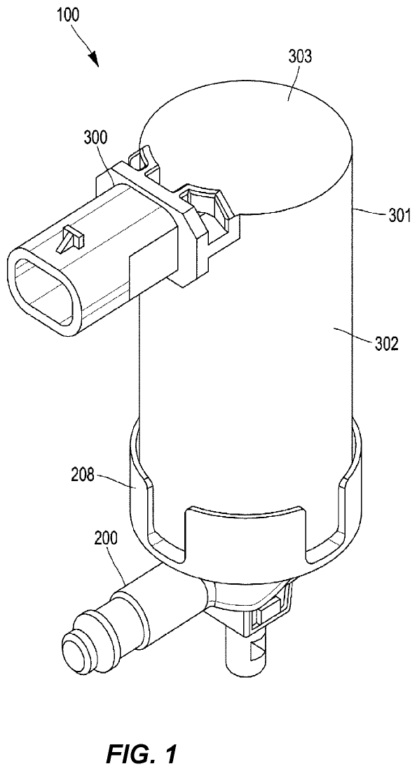

FIG. 1 is a schematic representation of an automatic valve 100 representative of an embodiment of the present disclosure.

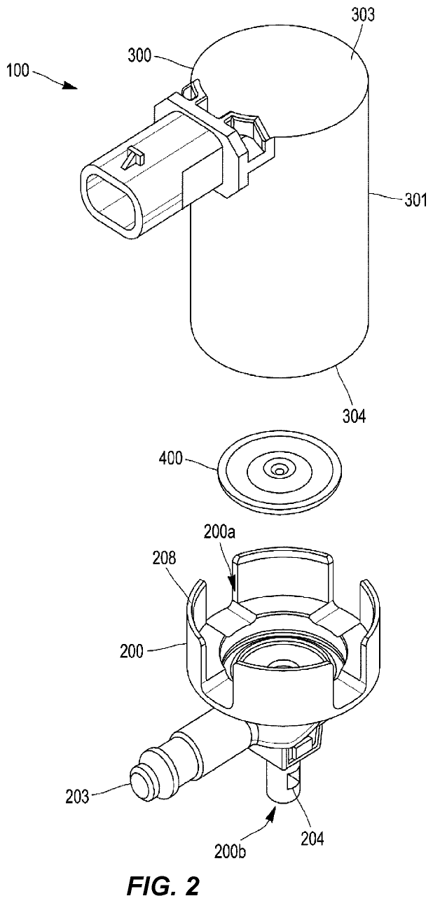

In particular, the automatic valve 100 comprises a valve body 200, an actuator 300 and a diaphragm 400 (FIGS. 1 and 2).

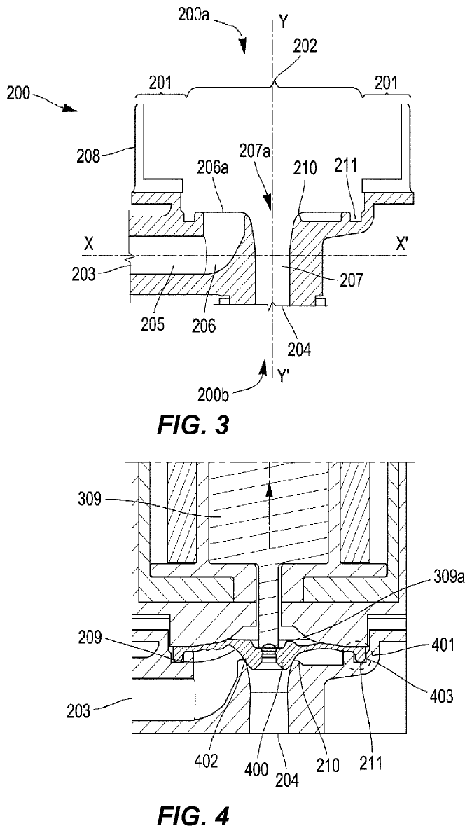

The valve body 200 (shown in FIG. 3) comprises, in a direction defined by an elongation axis YY′, an upstream face 200a and a downstream face 200b. It is understood that the upstream face 200a and the downstream face 200b are two opposite faces along the elongation axis YY′. The upstream face 200a has a circular shape, and, in particular, comprises a peripheral section 201 and a central section 202 recessed relative to the peripheral section 201.

The valve body 200 also comprises a fluid inlet 203 and a fluid outlet 204. The valve body 200 also comprises a radial duct 205, an intermediate elbow 206 as well as a longitudinal duct 207.

The radial duct 205 extends radially along a radial axis XX′ perpendicular to the elongation axis YY′, from the fluid inlet 203 to a downstream part. The intermediate elbow 206 extends from the downstream part and opens into the central section 202 through an intermediate opening 206a of the central section 202 of the upstream face 200a. In the example shown and described above, the radial axis XX′ is perpendicular to the elongation axis YY′. However, the present disclosure is not limited just to this aspect, so that a person skilled in the art could consider a radial axis XX′ that is not perpendicular to the elongation axis YY′.

The central section 202 also comprises a central opening 207a from which the longitudinal duct 207 extends along the elongation axis YY′ to the fluid outlet 204.

The central opening 207a forms a seat, referred to as a valve seat 210, intended to cooperate with the diaphragm 400. This aspect is described in more detail below.

The peripheral section 201 is surmounted, on its periphery, by guide means 208. In particular, the guide means 208 are arranged to allow the assembly and/or the coupling of the actuator 300 with the valve body 200. In particular, the guide means 208 may comprise one or more walls that extend parallel to the elongation axis YY′ from an outer edge of the peripheral section 201. The guide means 208 are, in particular, provided to mate conformally to a lateral surface of the actuator 300.

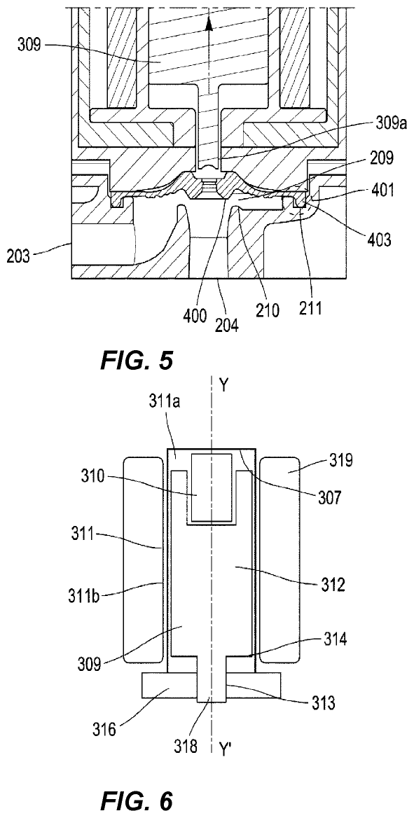

The actuator 300 comprises an outer envelope (or housing) 301, which may be generally cylindrical in shape. More particularly, the outer envelope 301 may comprise a lateral surface 302 connecting a first face 303 and a second face 304. The actuator 300 is coupled to the valve body 200 by its first face 303. More particularly, the actuator 300 is engaged by its first face 303 in the guide means 208 (FIGS. 4 and 5).

Moreover, the central section 202 and the first face 303 are shaped to provide a free space, called intermediate chamber 209, when the actuator 300 is engaged/coupled with the valve body 200. This intermediate chamber 209, delimited by the central section 202 and the first face 303, forms, with the radial duct 205, the intermediate elbow 206 and the longitudinal duct 207, a fluid duct. Thus, when a fluid flows in the fluid duct from the fluid inlet to the fluid outlet, it passes, in order, into the radial duct, the intermediate elbow, the intermediate chamber and the longitudinal duct.

The diaphragm 400, of generally circular shape, is interposed between the first face 303 and the upstream face 200a. The diaphragm 400 may advantageously comprise an elastomeric material, for example, an ethylene-propylene-diene methylene rubber (EPDM rubber). Alternatively, the diaphragm 400 may comprise a silicone rubber. More particularly, the diaphragm 400 comprises a circumferential part 401, and a central part 402 circumscribed by the circumferential part 401.

The central part 402, centered relative to the elongation axis YY′, is moreover in line with the valve seat 210. The diaphragm 400 is held by cooperation between the first face 303 and the central section 202 of the upstream face 200a. More particularly, this cooperation can exert a pinching of the circumferential part 401 of the diaphragm 400. Alternatively and/or additionally, the diaphragm 400 may be provided with a circular protrusion 403 formed on the circumferential part 401 and cooperating with a circumferential groove 211 formed on the central section 202 (FIG. 4). The central part 402 of the diaphragm 400 is kept floating in the intermediate chamber 209. The central part 402 of the diaphragm 400 is further configured to adopt, by deformation, either a closed position or an open position.

The closed or open position of the central part 402 will be used interchangeably throughout the description with that of the diaphragm 400. In other words, when the central part 402 is in a closed position, it will be considered that the diaphragm 400 is also in a closed position. In an equivalent manner, when the central part 402 is in an open position, it will be considered that the diaphragm 400 is also in an open position.

Thus, and according to the principles of the present disclosure, the closed position is a position for which the central part 402 bears against the valve seat 210 so as to seal the fluid duct. Conversely, the open position is a position wherein the central part 402 is recessed from the valve seat so as to make it possible for a fluid to flow in the fluid duct from the fluid inlet 203 to the fluid outlet 204.

The actuator 300 is provided with a stop 307, a spring 308, and a piston 309. In particular, the piston 309 comprises a main body of generally cylindrical shape and extending from a first end 309a toward a second end 309b along the elongation axis YY′. In this respect, the piston 309 is configured to move, by translation along the elongation axis YY′, between an engaged position (FIG. 4) and a disengaged position (FIG. 5).

The piston 309, by default and under the action of the spring 308, adopts the engaged position wherein it holds the diaphragm in its closed position. In particular, when it is in its engaged position, the piston 309 exerts a force by its first end 309a on the diaphragm 400, and more particularly on the central part 402 of the diaphragm 400, so that the latter remains bearing against the valve seat 210 and closes the fluid duct (FIG. 4).

The actuator 300 further comprises activation means configured to force the movement of the piston, toward the stop, from its engaged position to its disengaged position. The disengaged position is a position for which the first end 309a of the piston 309 is recessed from the central part 402 of the diaphragm 400. In this disengaged position, the piston 309 no longer exerts any force on the central part 402, thus enabling the diaphragm 400 to adopt its open position. In other words, when the piston 309 is in its disengaged position, a fluid can flow into the fluid duct from the fluid inlet 203 to the fluid outlet 204 (FIG. 5).

The actuator 300 comprises a damping body 310, interposed between the second end 309b and the stop 307. In this respect, the damping body 310 has a rigidity below that of the main body so as to dampen the movement of the piston when it moves from its engaged position to its disengaged position.

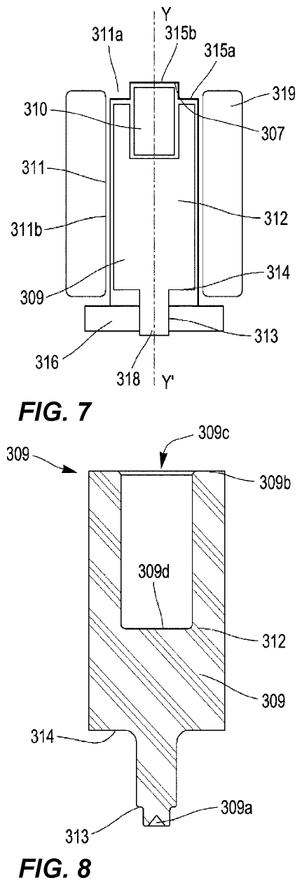

According to an advantageous embodiment, the damping body 310 is attached to the main body, for example, in the extension of the latter along its elongation axis YY′ (FIGS. 6 and 7). However, the present disclosure is not limited to this single embodiment, and it may be considered to attach the damping body 310 to the stop 307.

The remainder of this text will be limited just to the description of a damping body assembled to the piston. Nevertheless, a person skilled in the art will be able to adapt the teaching of the present disclosure and thus consider an assembly of the damping body to the guide body.

Regardless of the configuration considered, the damping body 310 makes it possible to dampen the impact between the stop and the piston during the passage from the engaged position to the disengaged position under the action of the activation means. The implementation of the damping body 310 according to the terms of the present disclosure makes it possible to reduce sound emissions (noise) likely to be emitted during operation of the automatic valve.

The actuator 300 can comprise a guide body 311 (FIGS. 6, 7, and 9) of cylindrical shape, mounted in the outer envelope 301 and coaxially therewith. The guide body 311 is provided with a bottom 311a surmounted by a wall, called guide wall 311b, delimiting a housing wherein the piston 309 is arranged in a sliding connection (FIGS. 6 and 7). In other words, the piston 309 is capable of changing from either the engaged position or the disengaged position by sliding in the guide body 311.

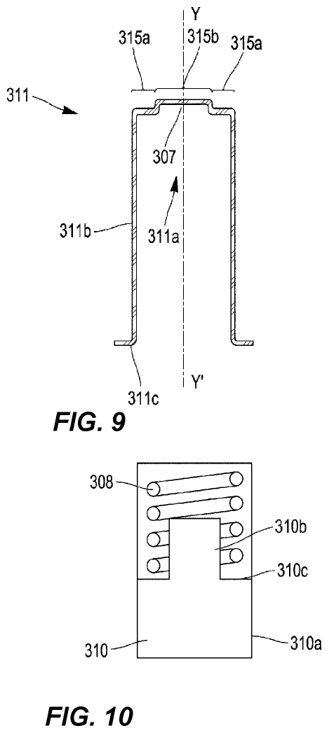

The guide wall 311b comprises an edge 311c, opposite the bottom 311a, and delimiting an opening. According to this configuration, the bottom 311a of the guide body forms the stop 307. The bottom 311a may comprise a peripheral zone 315a and a central zone 315b recessed relative to a reference plane defined by the peripheral zone 315a (FIGS. 7 and 9).

Advantageously, the main body comprises from the second end 309b toward the first end 309a a cylindrical ferromagnetic yoke 312 and an output shaft 313 of a diameter smaller than that of the ferromagnetic yoke so as to form a first shoulder 314 (FIGS. 6-8).

The actuator 300 may also comprise a cover 316 that sealably caps the edge of the guide body 311, advantageously by means of a seal (FIGS. 6 and 7).

The cover 316 comprises a circular opening 318 forming a passage for the output shaft 313.

Advantageously, the damping body 310 has rotational symmetry relative to the elongation axis YY′. The damping body is, for example, generally cylindrical in shape. The damping body 310 may comprise a polymeric material, advantageously the polymeric material is an elastomeric material.

The damping body may comprise a first section 310a and a second section 310b of a diameter smaller than that of the first section 310a so as to form a shoulder, called support shoulder 310c (FIG. 10). In particular, the spring 308 can be arranged coaxially with the second section 310b and bear against the bearing shoulder 310c. The first section 310a and the second section 310b may each be made of a different material.

Advantageously, the damping body 310 can be partially housed in a housing 309c, provided with a bottom 309d, of the main body (FIG. 8). According to this configuration, the second section 310b is in projection relative to the second end, and the spring 308 is also bearing against the stop 307. It is understood, although it is unnecessary to specify it, that the spring is kept in compression between the stop and the bearing shoulder.

Holding the damping body 310 by the previously proposed guide body can be implemented by inverting the damping body. More particularly, according to this configuration, the spring 308 bears against the bottom 309d of the housing 309c of the piston housing, and the first section 310a assembled to the bottom of the guide body.

The damping body can be rigidly connected to the guide body and more particularly can be in projection relative to the bottom. Under these conditions, the spring 308 is held in compression against the bottom 309d of the housing 309c of the piston 309.

The activation means may comprise at least one electromagnetic coil 319, advantageously wound around the guide body. More particularly, the electromagnetic coil 319 is arranged in a space provided between the guide body 311 and the outer envelope 301 (FIGS. 6 and 7). Control means 320 are arranged to control the flow of current in the electromagnetic coil 319.

The implementation of a structured bottom 311a and more particularly one that comprises a central zone 315b recessed from a reference plane defined by the peripheral zone 315a, makes it possible to limit the magnetic interactions between the electromagnetic coil 319 and the spring 308.

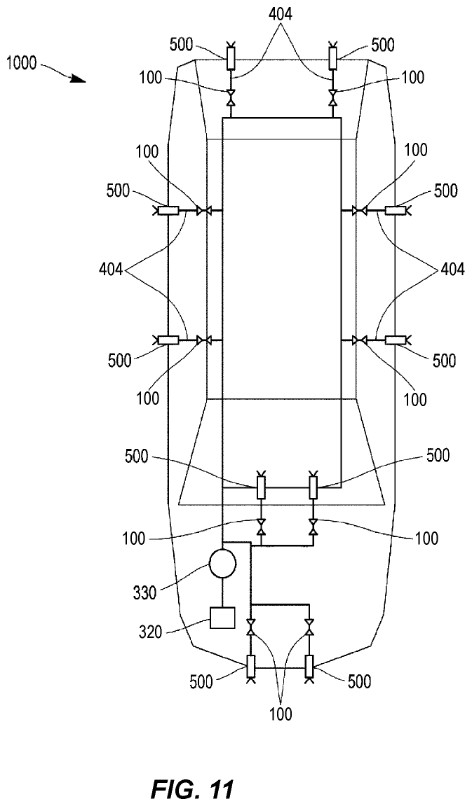

The present disclosure also relates to a fluid assembly for cleaning sensor surfaces of an autonomous vehicle 1000 (FIG. 11), the assembly comprising:
at least one automatic valve 100 according to the present disclosure;
a tank 330 of cleaning liquid;
at least one supply duct 404 arranged to fluidly connect the tank 330 of cleaning liquid and the fluid inlet of the at least one automatic valve 100; and
at least one nozzle 500, which is fluidically connected to the fluid outlet of the at least one automatic valve 100 and is arranged to spray the cleaning liquid onto a surface of the sensors.

1. An automatic valve for cleaning surfaces, comprising:
a valve body including a fluid duct connecting a fluid inlet and a fluid outlet of the valve body;
a diaphragm arranged to adopt, by deformation, either a closed position or an open position, the diaphragm sealing off the fluid duct when the diaphragm is in the closed position and allowing fluid to flow in the fluid duct from the fluid inlet to the fluid outlet when the diaphragm is in the open position; and
an actuator including a stop, a spring and a piston, the piston comprises a main body extending from a first end toward a second end along an axis of elongation, the piston configured to move, by translation along the axis of elongation, between an engaged position and a disengaged position, the piston adopting, by default and under action of the spring, the engaged position wherein the piston holds the diaphragm in the closed position, the actuator further comprising activation means configured to force the piston to move in the direction of the stop toward the disengaged position so as to allow the diaphragm to adopt the open position, the actuator comprising a damping body positioned between the second end and the stop, the damping body having a lower rigidity than a rigidity of the main body so as to dampen movement of the piston when the piston moves from the engaged position toward the disengaged position.

2. The automatic valve of claim 1, wherein the actuator comprises a cylindrical guide body, the guide body having a bottom surmounted by a guide wall delimiting a housing in which the piston is disposed, the piston configured to slide within the housing, the guide wall having an edge opposite the bottom and delimiting an opening.

3. The automatic valve of claim 2, wherein the bottom of the guide body forms the stop.

4. The automatic valve of claim 2, wherein the bottom comprises a peripheral zone and a central zone that is recessed with respect to a reference plane defined by the peripheral zone, the central zone forming the stop.

5. The automatic valve of claim 1, wherein the damping body is generally cylindrical in shape and comprises a first section and a second section that has a smaller diameter than a diameter of the first section so as to form a bearing shoulder.

6. The automatic valve of claim 5, wherein the spring is arranged coaxially with the second section and bears against the bearing shoulder.

7. The automatic valve of claim 5, wherein the first section and the second section are made of different materials.

8. The automatic valve of claim 5, wherein the damping body is partly housed in a housing of the main body.

9. The automatic valve of claim 8, wherein the second section has a projection with respect to the second end.

10. The automatic valve of claim 1, wherein the spring also bears against the stop.

11. The automatic valve of claim 1, wherein the damping body comprises a polymer material.

12. The automatic valve of claim 1, wherein the main body comprises, from the second end toward the first end, a cylindrical ferromagnetic yoke and an output shaft, the output shaft having a diameter smaller than a diameter of the ferromagnetic yoke so as to form a first shoulder.

13. The automatic valve of claim 12, wherein the actuator comprises a cylindrical guide body, the guide body having a bottom surmounted by a guide wall delimiting a housing in which the piston is disposed, the piston configured to slide within the housing, the guide wall having an edge opposite the bottom and delimiting an opening, and wherein the actuator further comprises a cover capping the edge of the guide body in a sealed manner.

14. The automatic valve of claim 13, wherein the cover comprises a circular opening providing a passage for the output shaft.

15. The automatic valve of claim 1, wherein the activation means comprise at least one electromagnetic coil.

16. The automatic valve of claim 1, wherein the valve body comprises a seat arranged in the fluid duct between the fluid inlet and the fluid outlet, the diaphragm located and configured to press against the seat when the piston is in the engaged position.

17. The automatic valve of claim 1, wherein the diaphragm comprises an elastomeric material.

18. A fluid assembly for cleaning surfaces, the assembly comprising:
at least one automatic valve according to claim 1;
a tank of cleaning liquid;
at least one supply duct that fluidically connects the tank of cleaning liquid and the fluid inlet of the at least one automatic valve; and
at least one nozzle that is fluidically connected to the fluid outlet of the at least one automatic valve and is arranged to project the cleaning liquid onto a surface of the vehicle.

19. The automatic valve of claim 11, wherein the polymer material comprises an elastomer material.

20. The automatic valve of claim 13, further comprising a seal between the cover and the edge of the guide body.
